(19) United States
(12) Patent Application Publication
(10) Pub. No.: US 2019/0234619 A1
(43) Pub. Date: Aug. 1, 2019

(54) DOOR AND OVEN HAVING THE SAME

(71) Applicant: Samsung Electronics Co., Ltd, Suwon-si (KR)

(72) Inventor: Dong Ho Lee, Suwon-si (KR)

(21) Appl. No.: 16/332,346

(22) PCT Filed: Aug. 22, 2017
(86) PCT No.: PCT/KR2017/009148

§ 371 Date: Mar. 11, 2019

(30) Foreign Application Priority Data
Sep. 9, 2016 (KR) 10-2016-0116793

(51) Int. Cl. F24C 15/04; E05B 1/00

(52) U.S. Cl. CPC F24C 15/04; E06B 3/38; E05B 1/003

(57) ABSTRACT

Disclosed is an oven capable of decreasing the temperature of a door by circulating air introduced into the door through the inside of the door. The oven includes a main body having an inlet port, a cooking chamber provided inside the main body, a cooling fan disposed above the cooking chamber to suck air through the inlet port and blow the air, and a door opening and closing the cooking chamber, and including a plurality of glasses, wherein at least one of the plurality of glasses has an inclined surface.

### CROSS-REFERENCE TO RELATED APPLICATIONS

This application is a 371 of International Application No. PCT/KR2017/009148 filed Aug. 22, 2017, which claims priority to Korean Patent Application No. 10-2016-0116793 filed Sep. 9, 2016, the disclosures of which are herein incorporated by reference in their entirety.

### BACKGROUND

### 1. Field

The present disclosure relates to an oven capable of decreasing the temperature of a door by circulating air introduced into the door inside the door.

### 2. Description of Related Art

Generally, an oven is an apparatus that cooks food by including a cooking chamber, a heating device for applying heat to the cooking chamber, and a circulation fan for circulating the heat generated by the heating device inside the cooking chamber.

That is, an oven is an apparatus that cooks food by sealing and heating food, and may generally be classified into an electric type, a gas type, and an electronic type according to a heat source.

Electric ovens use electric heaters as a heat source, and gas ovens and microwave ovens use heat of gas and frictional heat of water molecules due to high frequencies as heat sources, respectively.

The oven includes a main body forming an outer appearance and having an opened front surface and a cooking chamber into which foods to be cooked are introduced, and a door provided on the front surface of the main body to selectively open and close the cooking chamber.

The door is made of a plurality of glasses to prevent the heat inside the cooking chamber from being released to the outside.

However, since a door handle is provided on an upper portion of the door which maintains a high temperature, when a user grasps the door handle, the user may feel discomfort due to the high temperature.

Since the temperature of the door increases due to the heat inside the cooking chamber, an inlet port through which the outside air is sucked is provided on the door to prevent the temperature of the door from increasing. The air sucked into the inlet port is discharged to the outside of the door after decreasing the temperature of the door through the air channels provided between the plurality of glasses.

In contrast, the door must have an insulating performance that seals the inside of the cooking chamber so that hot heat does not escape out. When the insulating performance of the door is excellent, the time for cooking the food in the cooking chamber is reduced. The reduction of the cooking time leads to an advantageous effect such as increasing the energy efficiency by reducing the power consumption of the oven.

As a result, if only the cooling of the door is emphasized in order to prevent the temperature rise of the door caused by the heat transmitted from the cooking chamber, the insulating effect of the door may be reduced. Conversely, if only the insulation of the door is emphasized in order to prevent the heat transmitted from the cooking chamber from escaping out, the cooling effect of the door may be reduced.

Therefore, ovens require the development of doors that may meet the two conflicting requirements of cooling and insulation.

### SUMMARY

It is an aspect of the present disclosure to provide an oven having an improved door cooling structure to lower the temperature of the oven door.

It is an aspect of the present disclosure to provide an oven capable of reducing the heat loss occurring when the oven door is cooled.

It is an aspect of the present disclosure to provide an oven capable of preventing air stagnation phenomenon by air expanded as the temperature of the air rises.

In accordance with an aspect of the present disclosure, an oven may include a main body having an inlet port, a cooking chamber provided inside the main body, a cooling fan disposed above the cooking chamber to suck air through the inlet port and blow the air, and a door opening and closing the cooking chamber, and including a plurality of glasses, wherein at least one of the plurality of glasses may have an inclined surface.

The plurality of glasses may define at least one air channel, and the inclined surface may be formed such that a cross-sectional area of the at least one air channel varies along an airflow direction.

A cross-sectional area of a downstream side of the at least one air channel along the airflow direction may be wider than a cross-sectional area of an upstream side of the at least one air channel along the airflow direction.

At least one of the plurality of glasses may be disposed to be inclined.

The plurality of glasses may include an outer glass, an inner glass, and an intermediate glass disposed between the outer glass and the inner glass.

A gap between a lower portion of the outer glass and a lower portion of the intermediate glass may be larger than a gap between an upper portion of the outer glass and an upper portion of the intermediate glass.

A gap between an upper portion of the intermediate glass and an upper portion of the inner glass may be larger than a gap between a lower portion of the intermediate glass and a lower portion of the inner glass.

The intermediate glass may be disposed to be inclined.

At least one of the outer glass and the inner glass may be disposed to be inclined.

At least one of the plurality of glasses may include a protrusion protruding toward the at least one air channel so as to include the inclined surface.

The intermediate glass may include a first protrusion protruding toward the outer glass and a second protrusion protruding toward the inner glass.

The at least one air channel may include a first air channel formed between the outer glass and the intermediate glass, and a second air channel formed between the intermediate glass and the inner glass.

The inlet port may be disposed at an upper end of the door.

Air introduced into the inlet port may descend along the first air channel and may ascend along the second air channel.

The inlet port may be disposed at a lower end of the door, a gap between an upper portion of the outer glass and an upper portion of the intermediate glass may be larger than a gap between a lower portion of the outer glass and a lower portion of the intermediate glass, a gap between the upper portion of the intermediate glass and an upper portion of the inner glass may be larger than a gap between the upper portion of the outer glass and the upper portion of the intermediate glass, and a gap between the lower portion of the intermediate glass and a lower portion of the inner glass may be larger than a gap between the upper portion of the intermediate glass and the upper portion of the inner glass.

In accordance with another aspect of the present disclosure, an oven may include a main body having an inlet port, a cooking chamber provided inside the main body, a cooling fan disposed above the cooking chamber to suck air through the inlet port and blow the air, and a door opening and closing the cooking chamber and including an outer glass, an intermediate glass disposed at the rear of the outer glass and forming a first air channel with the outer glass, and an inner glass disposed at the rear of the intermediate glass and forming a second air channel with the intermediate glass, wherein a cross-sectional area of the first air channel may increase along an airflow direction in which air descends in the first air channel and a cross-sectional area of the second air channel may increase along an airflow direction in which air ascends in the second air channel.

The intermediate glass may be disposed to be inclined.

A gap between a lower portion of the outer glass and a lower portion of the intermediate glass may be 1.1 times larger than a gap between an upper portion of the outer glass and an upper portion of the intermediate glass.

In accordance with another aspect of the present disclosure, a door capable of being used in an oven may include an outer glass, an inner glass, and an intermediate glass positioned at the outer glass and the inner glass, wherein a first gap may be formed between an upper portion of the outer glass and an upper portion of the intermediate glass, a second gap may be formed between a lower portion of the outer glass and a lower portion of the intermediate glass, and at least one of the outer glass, the inner glass and the intermediate glass may include an inclined surface so that the first gap and the second gap is different from each other.

A third gap and a fourth gap may be further formed between the lower portion of the intermediate glass and a lower portion of the inner glass and between the upper portion of the intermediate glass and an upper portion of the inner glass, respectively, and the intermediate glass may be disposed to be inclined such that the second gap is larger than the first gap, the third gap is larger than the second gap, and the fourth gap is larger than the third gap.

The oven according to an embodiment of the present disclosure can enhance the cooling of a door because air of room temperature may be directly introduced into an upper end of the door by positioning an inlet port at the upper end of the door so that the air of room temperature may perform direct heat exchange with a door handle.

Since at least one air channel is formed between a plurality of glasses, air does not immediately contact an inner glass facing a cooking chamber, and first becomes relatively hot air by heat exchange with an outer glass. Therefore, since the hot air exchanges heat with the inner glass, the oven according to an embodiment of the present disclosure can improve energy efficiency by preventing the heat loss of the cooking chamber, which must maintain a high temperature during the cooking operation.

Since the cross-sectional area of the air channel formed between the plurality of glasses increases along the airflow direction, the oven according to an embodiment of the present disclosure can prevent air stagnation phenomenon by eddy flow of air expanded as the temperature of the air rises due to heat exchange with the door.

### BRIEF DESCRIPTION OF THE DRAWINGS

FIG. 1 is a perspective view of an oven according to an embodiment of the present disclosure.

FIG. 2 is a view illustrating a state in which a door of an oven according to an embodiment of the present disclosure is opened.

FIG. 3 is a side cross-sectional view of an oven according to an embodiment of the present disclosure.

FIG. 4 is a view illustrating air channels inside a door of an oven according to an embodiment of the present disclosure.

FIG. 5 is a view illustrating a structure in which an intermediate glass is disposed to be inclined in an oven according to an embodiment of the present disclosure.

FIG. 6 is a view illustrating a structure in which at least one of an outer glass and an inner glass is disposed to be inclined in an oven according to another embodiment of the present disclosure.

FIG. 7 is a view illustrating a structure in which an intermediate glass is disposed to be inclined in an oven according to another embodiment of the present disclosure.

FIGS. 8 and 9 are views illustrating a structure in which an intermediate glass includes protrusions in an oven according to another embodiment of the present disclosure.

FIG. 10 is a view illustrating the position of an outlet port in an oven according to another embodiment of the present disclosure.

### DETAILED DESCRIPTION

Hereinafter, preferred embodiments of the present disclosure will be described in detail with reference to the accompanying drawings.

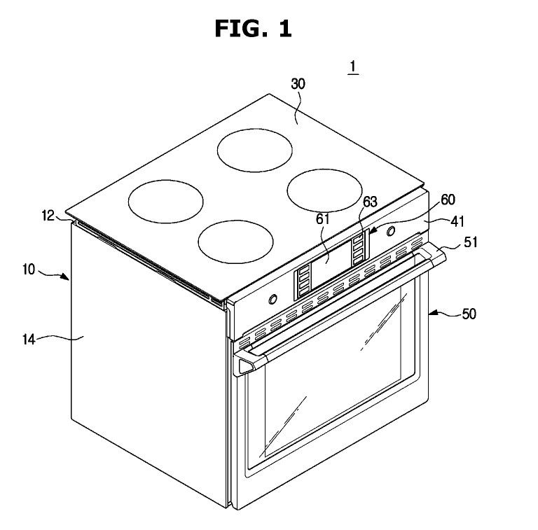

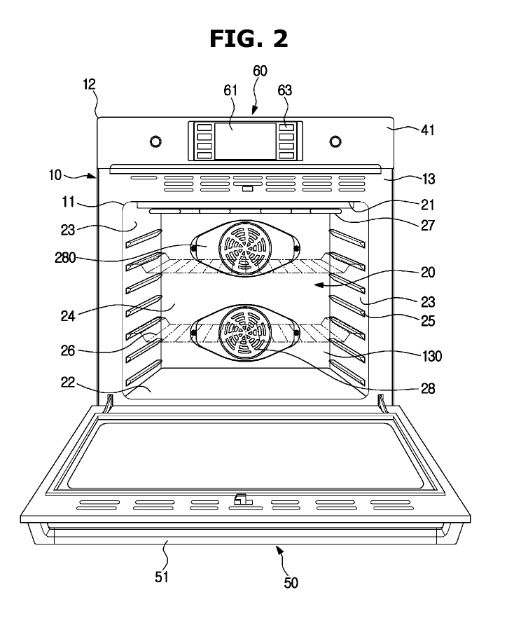

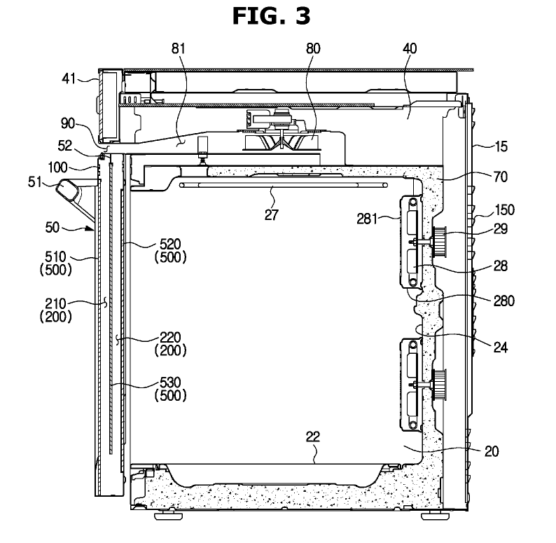

FIG. 1 is a perspective view of an oven according to an embodiment of the present disclosure, FIG. 2 is a view illustrating a state in which a door of an oven according to an embodiment of the present disclosure is opened, and FIG. 3 is a side cross-sectional view of an oven according to an embodiment of the present disclosure.

As illustrated in FIGS. 1 to 3, an oven 1 includes a main body 10 including an inner case 11 in which a cooking chamber 20 is formed and an outer case 12 coupled to the outside of the inner case 11 to form an outer appearance of the oven 1. The inner case 11 and the outer case 12 may have a substantially box-like shape with a front surface thereof opened.

The oven 1 may include a cooktop 30 provided at the top of the oven 1 and capable of placing and heating a container on which food is placed. The oven 1 may include a door 50 provided on a front surface of the main body 10 to open and close the cooking chamber 20.

The outer case 12 may include a front panel 13 forming the front surface of the main body 10, side panels 14 forming side surfaces of the main body 10, and a rear panel 15 forming a rear surface of the main body 10.

The front panel 13 is provided with an opening 130 and a front surface of the cooking chamber 20 provided inside the main body 10 may be opened by the opening 130.

An electrical component chamber cover 41 covering a front surface of an electrical component chamber 40, which will be described later, may be provided above a front surface of the front panel 13. A display module 60, which will be described later, may be mounted on the electrical component chamber cover 41.

The rear panel 15 may be provided with through holes 150 to allow air to be sucked into the electrical component chamber 40, which will be described later. The air sucked into the electrical component chamber 40 through the through holes 150 may flow through the electrical component chamber 40 to cool electrical components.

The cooking chamber 20, which is formed in a box shape inside the main body 10 and has an opened front surface, may be formed by an upper plate 21, a bottom plate 22, opposite side plates 23, and a rear plate 24. The front surface of the cooking chamber 20 is opened through the opening 130 of the front panel 13 so that the food may be put into and taken out of a cooking cavity.

A plurality of support rods 25 may be provided on an inner surface of the opposite side plates 23. At least one removable rack 26 capable of loading food may be mounted on the plurality of support rods 25. The plurality of support rods 25 may be provided with rails (not shown) so that the rack 26 may be slidably moved. The user may move the rack 26 through the rails to remove or load food.

Dividers (not shown) capable of dividing the cooking chamber 20 into a plurality of spaces may be detachably mounted on the plurality of support rods 25. The plurality of spaces of the cooking chamber 20 divided by the dividers (not shown) need not be the same in size, but may be different in size from each other.

Accordingly, the user may utilize the plurality of spaces of the cooking chamber 20 variously according to his or her intention. The dividers may be made of a heat insulating material so as to insulate each space of the cooking chamber 20.

The cooking chamber 20 may be provided with a heater 27 for heating the food, and the heater 27 may be an electric heater including an electric resistor. However, the heater 27 is not limited to an electric heater, and may be a gas heater that generates heat by burning gas. Thus, the oven may include an electric oven and a gas oven.

The rear plate 24 of the cooking chamber 20 may be provided with circulation fans 28 for circulating the air in the cooking chamber 20 to heat the food evenly and circulation motors 29 for driving the circulation fans 28.

A fan cover 280 covering each of the circulation fans 28 may be provided at the front of each of the circulation fans 28 and outflow holes 281 may be formed on the fan cover 280 to allow air to flow therethrough.

The opened front surface of the cooking chamber 20 may be opened and closed by the door 50, and the door 50 may be hinged to a lower portion of the main body 10 so as to be rotatable with respect to the main body 10.

A door handle 51 may be provided at an upper portion of the front surface of the door 50 so that the door 50 may be opened and closed by the user. The detailed configuration of the door 50 will be described later.

The display module 60, which displays various operation information of the oven 1 and allows the user to input an operation command, may be mounted on the electrical component chamber cover 41 provided above the front surface of the front panel 11. The electrical component chamber cover 41 may be provided with an operation portion 63 for operating the oven 1.

The display module 60 may include a liquid crystal display (LCD) 61, and the liquid crystal display 61 may display electrical information as visual information using a change in liquid crystal transmittance according to an applied voltage.

The liquid crystal display 61 may include a liquid crystal module for displaying an image and a light source unit for emitting light to the liquid crystal module, and LEDs (light emitting diodes) may be used as the light source unit.

The display module 60 may include a cover panel (not shown) provided on a front surface of the liquid crystal display 61. The cover panel may be simply a protective panel for protecting the liquid crystal display 61, but may be a touch panel capable of receiving a user's touch command.

Various components constituting the oven 1 may be installed in a space between the inner case 11 in which the cooking chamber 20 is formed and the outer case 12 forming the outer appearance of the oven 1. In addition, the electrical component chamber 40 accommodating electrical components for controlling the operation of various accessories including the display module 60 may be provided in the space.

A heat insulating material 70 for insulating the electrical component chamber 40 and the cooking chamber 20 may be provided between the electrical component chamber 40 and the cooking chamber 20 in order to prevent the heat in the cooking chamber 20 from being transmitted to the electrical component chamber 40.

The heat insulating material 70 may be provided to cover the entire outside of the cooking chamber 20 so that the heat in the cooking chamber 20 is not transmitted to the outside of the oven 1 as well as between the electrical component chamber 40 and the cooking chamber 20.

A cooling structure for cooling the electrical component chamber 40 by circulating air around the electrical component chamber 40 is provided in the oven 1 because the temperature inside the electrical component chamber 40 may be raised by the heating of various electric components.

The cooling structure of the oven 1 may include a cooling fan 80 for flowing air and a cooling channel 81 for discharging the air sucked by the cooling fan 80 to the front of the oven 1.

The cooling fan 80 may discharge air in a radial direction after sucking the air in an axial direction. That is, the cooling fan 80 may be a centrifugal fan. However, the present disclosure is not limited thereto, and an axial flow fan may be used as the cooling fan 80, unlike the present embodiment.

The outside air may be sucked into the electrical component chamber 40 through the through holes 150 formed on the rear panel 15, and the air sucked into the electrical component chamber 40 may flow the inside of the electrical component chamber 40 to cool the electrical components, and then may flow along the cooling channel 81 to be discharged to the front of the oven 1 through an outlet port 90.

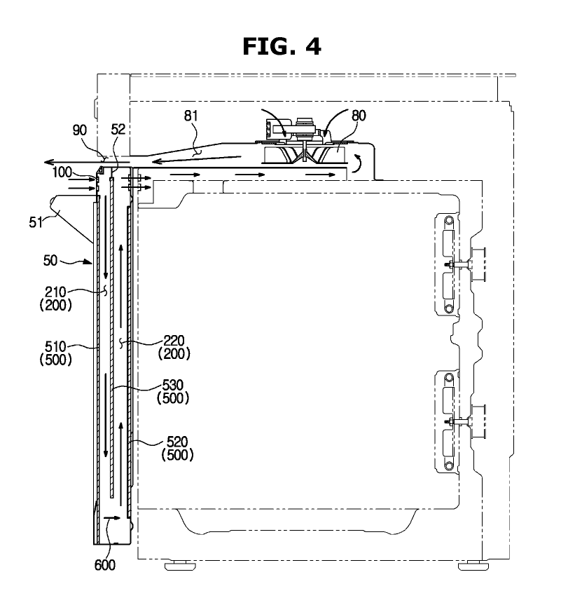

FIG. 3 is a side cross-sectional view of an oven according to an embodiment of the present disclosure, and FIG. 4 is a view illustrating air channels inside a door of an oven according to an embodiment of the present disclosure.

As illustrated in FIGS. 3 and 4, the door 50 may include a plurality of glasses 500. The plurality of glasses 500 may include an outer glass 510 forming an outer surface of the door 50 and an inner glass 520 forming an inner surface of the door 50. The plurality of glasses 500 may further include an intermediate glass 530 provided between the outer glass 510 and the inner glass 520.

The door handle 51 may be provided at an upper portion of the outer glass 510 so that the door 50 may be opened and closed by the user. The inner glass 520 may be arranged to seal the cooking chamber 20.

The cooking process of the oven 1 will be described below. The user may place food on the rack 26 supported by the plurality of support rods 25 and close the door 50 to seal the cooking chamber 20. Thereafter, the heater 27 may be operated through the operating portion 63 provided on the electrical component chamber cover 41 to generate heat, and the circulation fan 28 may be rotated by the circulation motor 29.

In the cooking process, the temperature inside the cooking chamber 20 may rise, and the heat in the cooking chamber 20 may be transmitted to the door 50 located at the front surface of the cooking chamber 20. Since the door 50 is frequently contacted by the user, it may be an important problem in the oven 1 to reduce the uncomfortable feeling of the user using the door 50 whose temperature has risen.

Accordingly, in order to cool the door 50 heated by the heat inside the cooking chamber 20, the oven 1 may include the cooling fan 80 for cooling the electrical component chamber 40, and an inlet port 100 through which the outside air (room temperature) may flow into the door 50.

The door 50 may include a fixing frame 52 for fixing the plurality of glasses 500 and at least one air channel 200 may be formed in spaces between the plurality of glasses 500.

The door 50 may be configured to form the one air channel 200 between the outer glass 510 and the inner glass 520. The door 50 may include the intermediate glass 530 to form a first air channel 210 between the outer glass 510 and the intermediate glass 530 and to form a second air channel 220 between the intermediate glass 530 and inner glass 520.

Although FIG. 3 illustrates that the one intermediate glass 530 is provided, the present disclosure is not limited thereto and two or more of the intermediate glasses 530 may be provided.

The number of the air channels 200 is not limited to two including the first air channel 210 and the second air channel 220. The number of the air channels 200 may be appropriately set depending on the number of the intermediate glasses 530.

As a general cooling process of the door 50, the cooling fan 80 sucks the outside air through the inlet port 100 and may discharge the sucked air again. The air circulated by the cooling fan 80 may flow along the air channels 200 inside the door 50 to exchange heat with the plurality of glasses 500 of the door 50.

The air may flow along the cooling channel 81 and be discharged in the front direction of the oven 1 through the outlet port 90 after cooling the door 50 through heat exchange.

When the width of the cooling channel 81 adjacent to the outlet port 90 is relatively narrow, the velocity of air discharged to pass the same amount of air through the outlet port 90 may increase.

As the velocity of the air increases, the pressure of the air may be relatively lower than atmospheric pressure. Therefore, the venturi effect in which the atmospheric pressure air is naturally sucked into the position where the air pressure is lowered may occur.

The door 50 may be cooled by utilizing the phenomenon that the pressure in the upper portion of the door 50 through which the discharged air escapes is relatively lowered and the surrounding air collects at the upper portion of the door 50.

Since the inlet port 100 of the oven 1 is generally located at a lower end of the door 50, the cooling process of the door 50 may be started by the inflow of outside air into the lower end of the door 50. The inflow air may rise up to the upper portion of the door 50 along the air channels 200.

The air may be brought to a relatively high temperature relative to the temperature of the air when it is introduced due to the heat exchange through the cooling of the lower portion of the door 50. Therefore, even if the room temperature air is introduced, the cooling efficiency at the upper portion of the door 50 may be lower than the cooling efficiency at the lower portion of the door 50.

The oven 1 according to an embodiment of the present disclosure may be configured such that the position of the inlet port 100 is disposed at the upper end of the door 50 rather than the lower end of the door 50. The outside air at room temperature for cooling the door 50 is introduced immediately into the upper end of the door 50 on which the door handle 51 is located to perform direct heat exchange.

The efficiency of cooling the upper portion of the door 50 may be increased relatively when the inlet port 100 is positioned at the upper end of the door 50 rather than the lower end of the door 50.

Contrary to the cooling of the door 50 being an important problem, the cooking chamber 20 itself needs to maintain a high temperature during the cooking operation. Particularly, when the inside of the cooking chamber 20 is self-cleaned, heat of s higher temperature may be required. Therefore, heat generated inside the cooking chamber 20 may need to be maintained without being released from the cooking chamber 20.

The self-cleaning may be a method using a pyrolytic-cleaning function. In general, when food is heated and cooked in the cooking chamber 20 and then oil or the like, which comes from the food, adheres to the inner wall surface of the cooking chamber 20 and is hardened, it is difficult for the user to clean the cooking chamber 20.

When the pyrolytic-cleaning function is used, cleaning may proceed smoothly. Pyrolytic-cleaning may be a method of burning and removing pollutants by keeping the internal temperature of the cooking chamber 20 at a considerably high temperature for a long time by using the heater 27.

For the pyrolytic-cleaning, higher temperatures may be required than during normal cooking operations.

If the air for cooling the door 50 simultaneously collectively cools the inner glass 520 sealing the cooking chamber 20 as well as the outer glass 510, the energy loss may be caused in a general cooking operation, and the performance in performing the pyrolytic-cleaning function may also be deteriorated.

The oven 1 according to an embodiment of the present disclosure may include the at least one air channel 200 in order to prevent the inner glass 520 from being directly cooled at the same time when air of room temperature cools the outer glass 510.

The door 50 may include the intermediate glass 530 that may form one continuous air channel such as a meander line through the fixing frame 52. By the one continuous air channel, the air of room temperature introduced through the inlet port 100 may not directly conduct heat exchange with the inner glass 520 immediately.

The air introduced into the door 50 first passes through the first air channel 210 formed between the outer glass 510 and the intermediate glass 530 and may perform heat exchange. Thereafter, the air may pass through the second air channel 220 formed between the intermediate glass 530 and the inner glass 520.

The temperature of the air passing through the second air channel 220 may be relatively high compared to the temperature of the air passing through the first air channel 210. Therefore, the additional energy loss required to maintain the cooking chamber 20 at a high temperature may be reduced.

The inlet port 100 may be positioned anywhere in the oven 1, such as the upper end of the door 50 and the lower end of the door 50. However, the inlet port 100 of the oven 1 according to an embodiment of the present disclosure is preferably positioned at the upper end of the door 50.

It may be preferred that an airflow direction 600 in which the air introduced into the inlet port 100 first descends along the first air channel 210 and then rises along the second air channel 220 again may be formed.

It may be preferable that the air introduced into the inlet port 100 descends first along the first air channel 210 and then flows so that an airflow direction 600 ascending along the second air channel 220 may be formed.

The air sucked through the inlet port 100 is in a relatively low temperature state compared to the air inside the door 50, and low-temperature air has the property of descending, so that a natural descending airflow may be formed.

The air that has descended to the lower end of the door 50 may have a relatively high temperature by heat exchange with the door 50 while passing through the first air channel 210. high-temperature air has the property of ascending, so that a natural ascending airflow may be formed.

As illustrated in FIGS. 3 and 4, the number of inner glasses 520 may be generally one. However, in the case of the oven 1 performing the pyrolytic-cleaning function, it is preferable that in order to maintain the cooking chamber 20 at a high temperature, the number of the inner glasses 520 is configured as two and the space between the inner glasses 520 is formed in a sealed structure.

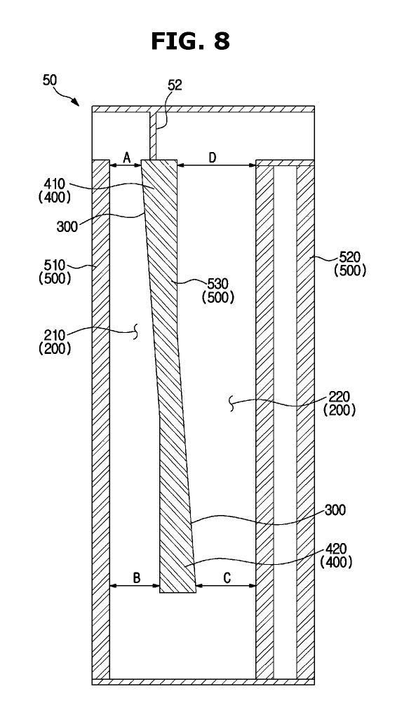

Referring to FIG. 8, a structure in which the inner glass 520 is composed of two pieces and the space between the pieces is sealed is illustrated.

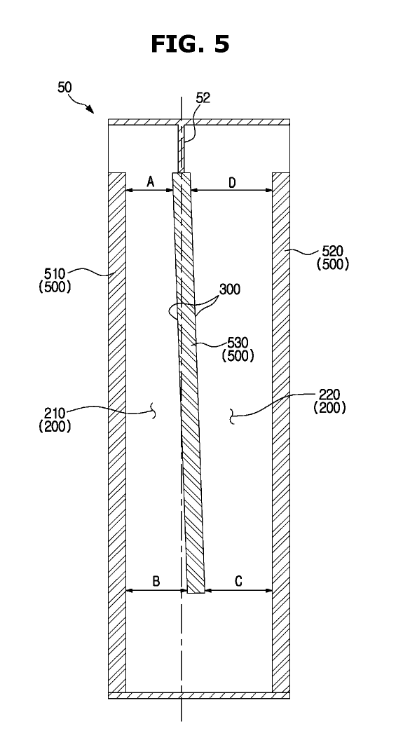

FIG. 5 is a view illustrating a structure in which an intermediate glass is disposed to be inclined in an oven according to an embodiment of the present disclosure. Referring to FIG. 5, in the oven 1 according to an embodiment of the present disclosure, the air channels 200 may be composed of two or more including the intermediate glass 530.

In the cooling process of the door 50 of the oven 1, the space of the air channels 200 may be generally defined. The temperature of the air in the air channels 200 may be increased by heat exchange with the door 50, and the volume of the air may expand due to an increase in temperature.

The expanded air may generate a vortex, which may block high temperature air from being discharged naturally to the outside along the airflow direction 600 and cause air stagnation phenomenon in the inside of the door 50.

When the intermediate glass 530 is disposed so as to be spaced apart from the outer glass 510 and the inner glass 520 by the same gap, the cross-sectional area of the first air channel 210 and the cross-sectional area of the second air channel 220 become equal.

There may be a case where the intermediate glass 530 is disposed to be closer to the outer glass 510 than the inner glass 520. In this case, since the cross-sectional area of the second air channel 220 becomes larger than the cross-sectional area of the first air channel 210, considering the airflow direction 600, the above case may be more effective in preventing the air stagnation phenomenon.

In the oven 1 according to an embodiment of the present disclosure, the position of the intermediate glass 530 may be determined such that the cross-sectional area of the second air channel 220 may be larger than the cross-sectional area of the first air channel 210.

In addition, at least one of the plurality of glasses 500 may include an inclined plane 300, so that the cross-sectional area of the air channel 200 may be changed along the airflow direction 600.

Preferably, at least one of the plurality of glasses 500 may include the inclined surface 300 such that the cross-sectional area on a downstream side of the air channel 200 may be larger than the cross-sectional area on an upstream side, so that the cross-sectional area of the air channel 200 may vary along the airflow direction 600.

Herein, the meanings of the upstream side and the downstream side are not limited to the meaning of physical upper and lower sides in the air channel 200 of the oven 1. This may be used to express air flowing from the upstream side, which means a portion close to the origin of the airflow, to the downstream side along the airflow direction 600.

The intermediate glass 530 may be disposed to be inclined, and the position of the intermediate glass 530 may be disposed to be closer to the outer glass 510 than the inner glass 520. Accordingly, a gap between a lower portion of the outer glass 510 and a lower portion of the intermediate glass 530 may be larger than a gap between an upper portion of the outer glass 510 and an upper portion of the intermediate glass 530.

A gap between the lower portion of the intermediate glass 530 and a lower portion of the inner glass 520 may be larger than a gap between the lower portion of the outer glass 510 and the lower portion of the intermediate glass 530. A gap between the upper portion of the intermediate glass 530 and an upper portion of the inner glass 520 may be larger than a gap between the lower portion of the intermediate glass 530 and the lower portion of the inner glass 520.

The air introduced into the inlet port 100 positioned at the upper end of the door 50 may pass through the first air channel 210 and the second air channel 220 along the airflow direction 600 in order to cool the door 50.

As the temperature of the air rises and the volume of the air expands due to the heat exchange between the air and the door 50, the cross-sectional area of the at least one air channel 200 is widened along the airflow direction 600 by the inclined surface 300 of the intermediate glass 530. Because of this, the air stagnation phenomenon may be prevented.

The gap between the upper portion of the outer glass 510 and the upper portion of the intermediate glass 530 may correspond to an upper gap A of the first air channel 210. The gap between the lower portion of the outer glass 510 and the lower portion of the intermediate glass 530 may correspond to a lower gap B of the first air channel 210.

The gap between the lower portion of the intermediate glass 530 and the lower portion of the inner glass 520 may correspond to a lower gap C of the second air channel 220. The gap between the upper portion of the intermediate glass 530 and the upper portion of the inner glass 520 may correspond to an upper gap D of the second air channel 220.

The size of the cross-sectional area of the at least one air channel 200 may be proportional to the upper and lower gaps A, B, C, and D of the at least one air channel 200.

A preferable difference in gaps of the at least one air passage 200 for improving the cooling efficiency of the door 50 by preventing the air stagnation phenomenon may be as follows.

Specifically, the intermediate glass 530 may be disposed to be inclined such that the lower gap B of the first air channel 210 is at least 1.1 times larger than the upper gap A of the first air channel 210.

The intermediate glass 530 may be disposed to be inclined such that the lower gap C of the second air channel 220 is at least 1.1 times larger than the lower gap B of the first air channel 210. The intermediate glass 530 may be disposed to be inclined such that the upper gap D of the second air channel 220 is at least 1.1 times larger than the lower gap C of the second air channel 220.

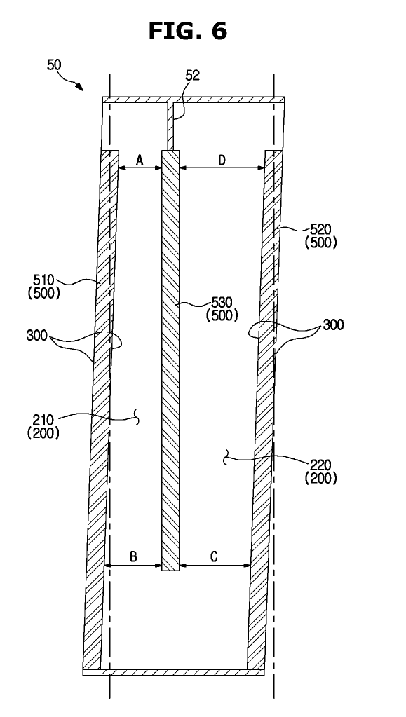

FIG. 6 is a view illustrating a structure in which at least one of an outer glass and an inner glass is disposed to be inclined in an oven according to another embodiment of the present disclosure.

Referring to FIG. 6, the outer glass 510 and the inner glass 520 may be disposed to be inclined, and the intermediate glass 530 may be disposed to be closer to the outer glass 510 than the inner glass 520.

Accordingly, the lower gap B of the first air channel 210 may be larger than the upper gap A of the first air channel 210. The lower gap C of the second air channel 220 may be larger than the lower gap B of the first air channel 210. The upper gap D of the second air channel 220 may be larger than the lower gap C of the second air channel 220.

As the temperature of the air rises and the volume of the air expands due to the heat exchange between the air and the door 50, the cross-sectional area of the at least one air channel 200 may be widened along the airflow direction 600 by the inclined surface 300 of the intermediate glass 530. Therefore, the air stagnation phenomenon may be prevented.

FIG. 5 illustrates that only the intermediate glass 530 is disposed to be inclined, and FIG. 6 illustrates that only the outer glass 510 and the inner glass 520 are disposed to be inclined. However, the present disclosure is not limited thereto.

In the present disclosure, at least one of the outer glass 510 and the inner glass 520 and the intermediate glass 530 may be disposed to be inclined together, and the inclination angle of each of the plurality of glasses 500 may be different.

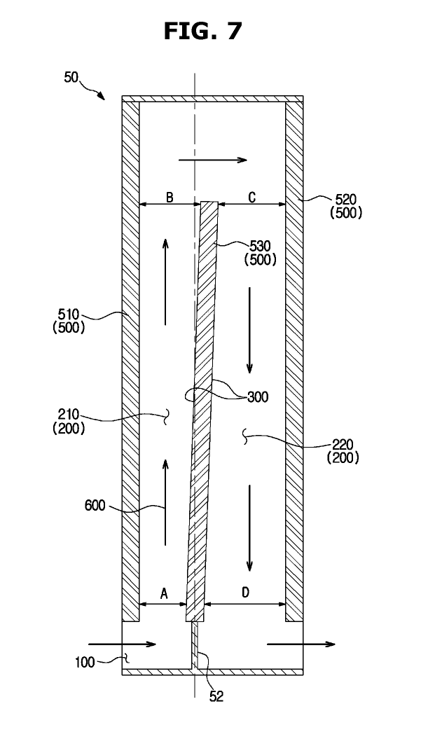

FIG. 7 is a view illustrating a structure in which an intermediate glass is disposed to be inclined in an oven according to another embodiment of the present disclosure.

The embodiment of FIG. 7 may correspond to an embodiment in which the inlet port 100 is positioned at the lower end of the door 50, not the upper end of the door 50. In this case as well, air passing through the at least one air channel 200 may flow along the airflow direction 600, so that the energy loss of the cooking chamber 20 may be reduced.

Also, at least one of the plurality of glasses 500 includes the inclined surface 300, so that the air stagnation phenomenon may be prevented.

Air may be sucked from the inlet port 100 positioned at the lower end of the door 50. The air may pass through the lower gap B of the first air channel 210, the upper gap A of the first air channel 210, the lower gap D of the second air channel 220, and the upper gap C of the second air channel 220 sequentially.

By the airflow direction 600 as above, as in the case where the inlet port 100 is positioned at the upper end of the door 50, since the temperature of the air passing through the second air channel 220 is relatively high, the energy loss of the cooking chamber 20 may be reduced.

The intermediate glass 530 may be disposed to be inclined in the direction opposite to the intermediate glass 530 of the oven 1 according to an embodiment of the present disclosure, and the intermediate glass 530 may be disposed to be closer to the outer glass 510 than the inner glass 520.

The upper gap A of the first air channel 210 may be larger than the lower gap B of the first air channel 210. The upper gap D of the second air channel 220 may be larger than the upper gap A of the first air channel 210. The lower gap C of the second air channel 220 may be larger than the upper gap D of the second air channel 220.

As in the case where the inlet port 100 is positioned at the upper end of the door 50, the air channel 200 may be formed not by being coupled with the fixing frame 52 and the upper end of the intermediate glass 530 but by being coupled with the fixing frame 52 and the lower end of the intermediate glass 530.

The airflow direction 600 in which the air introduced through the inlet port 100 positioned at the lower end of the door 50 ascends along the first air channel 210 and then descends along the second air channel 220 may be formed.

As the temperature of the air rises and the volume of the air expands due to the heat exchange between the air and the door 50, the cross-sectional area of the at least one air channel 200 may be widened along the airflow direction 600 by the inclined surface 300 of the intermediate glass 530. Therefore, the air stagnation phenomenon may be prevented.

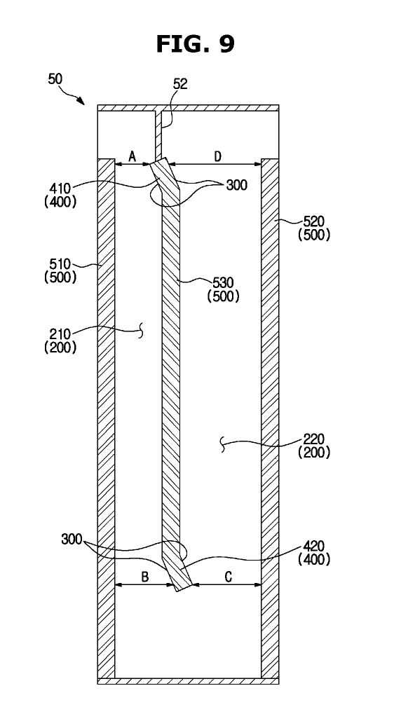

FIGS. 8 and 9 are views illustrating a structure in which an intermediate glass includes protrusions in an oven according to another embodiment of the present disclosure.

FIGS. 8 and 9 may correspond to an embodiment in which at least one of the plurality of glasses 500 includes a protrusion 400 protruding toward the at least one air channel 200 so as to include the inclined surface 300.

The preferred embodiment may be a structure in which the intermediate glass 530 includes the protrusion 400 so that the intermediate glass 530 among the plurality of glasses 500 includes the inclined surface 300.

The protrusion 400 of the intermediate glass 530 may include a first protrusion 410 protruding toward the outer glass 510 and a second protrusion 420 protruding toward the inner glass 520.

One of the plurality of glasses 500 may include the inclined surface 300 by including the protrusion 400. The intermediate glass 530 may be disposed to be closer to the outer glass 510 than the inner glass 520.

The lower gap B of the first air channel 210 may be larger than the upper gap A of the first air channel 210. The lower gap C of the second air channel 220 may be larger than the lower gap B of the first air channel 210. The upper gap D of the second air channel 220 may be larger than the lower gap C of the second air channel 220.

As the temperature of the air rises and the volume of the air expands due to the heat exchange between the air and the door 50, the cross-sectional area of the at least one air channel 200 may be widened along the airflow direction 600 by the inclined surface 300 of the intermediate glass 530. Therefore, the air stagnation phenomenon may be prevented.

Although FIG. 8 illustrates that only the intermediate glass 530 includes the protrusion 400, this is only an example of a preferred structure, but is not limited thereto. In the present disclosure, at least one of the outer glass 510 and the inner glass 520 may include the protrusion 400.

Referring to FIG. 9, the intermediate glass 530 may include the protrusions 400 by bending opposite ends of the intermediate glass 530. The protrusions 400 are not limited to those illustrated in FIGS. 8 and 9, and the plurality of glasses 500 may have various structures that may include the protrusions 400.

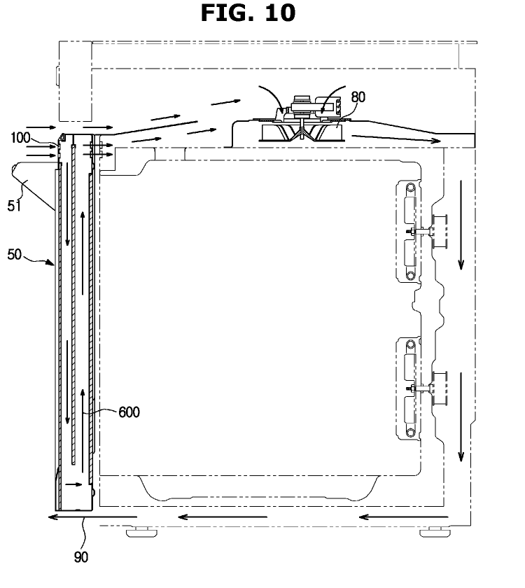

FIG. 10 is a view illustrating the position of an outlet port in an oven according to another embodiment of the present disclosure.

Referring to FIG. 10, in a case where the outlet port 90 of the oven 1 is positioned higher than the inlet port 100, the discharged air may cause an uncomfortable feeling to the user using the oven 1.

The discharged air may be mixed with the air at room temperature to affect the temperature of the air introduced through the inlet port 100. It is preferable that the outlet port 90 of the oven 1 according to another embodiment of the present disclosure is disposed at the lower end of the door 50.

However, the position of the outlet port 90 of the present disclosure is not limited to the lower end of the door 50.

Although the technical idea of the present disclosure has been described above with the specific embodiments, the scope of the present disclosure is not limited to these embodiments.

It will be understood by those skilled in the art that various changes in form and details may be made therein without departing from the spirit and scope of the present disclosure as defined by the appended claims.

1. An oven comprising:
a main body having an inlet port;
a cooking chamber provided inside the main body;
a cooling fan disposed above the cooking chamber to suck air through the inlet port and blow the air; and
a door opening and closing the cooking chamber, and including a plurality of glasses, wherein at least one of the plurality of glasses has an inclined surface.

2. The oven according to claim 1, wherein:
the plurality of glasses defines at least one air channel, and
the inclined surface is formed such that a cross-sectional area of the at least one air channel varies along an airflow direction.

3. The oven according to claim 2, wherein:
a cross-sectional area of a downstream side of the at least one air channel along the airflow direction is wider than a cross-sectional area of an upstream side of the at least one air channel along the airflow direction.

4. The oven according to claim 1, wherein:
at least one of the plurality of glasses is disposed to be inclined.

5. The oven according to claim 2, wherein:
the plurality of glasses includes an outer glass, an inner glass, and an intermediate glass disposed between the outer glass and the inner glass.

6. The oven according to claim 5, wherein:
a gap between a lower portion of the outer glass and a lower portion of the intermediate glass is larger than a gap between an upper portion of the outer glass and an upper portion of the intermediate glass.

7. The oven according to claim 5, wherein:
a gap between an upper portion of the intermediate glass and an upper portion of the inner glass is larger than a gap between a lower portion of the intermediate glass and a lower portion of the inner glass.

8. The oven according to claim 5, wherein:
the intermediate glass is disposed to be inclined.

9. The oven according to claim 5, wherein:
at least one of the outer glass and the inner glass is disposed to be inclined.

10. The oven according to claim 2, wherein:
at least one of the plurality of glasses includes a protrusion protruding toward the at least one air channel so as to include the inclined surface.

11. The oven according to claim 5, wherein:
the intermediate glass includes a first protrusion protruding toward the outer glass and a second protrusion protruding toward the inner glass.

12. The oven according to claim 5, wherein:
the at least one air channel includes a first air channel formed between the outer glass and the intermediate glass, and a second air channel formed between the intermediate glass and the inner glass.

13. The oven according to claim 12, wherein:
the inlet port is disposed at an upper end of the door.

14. The oven according to claim 13, wherein:
air introduced into the inlet port descends along the first air channel and ascends along the second air channel.

15. The oven according to claim 5, wherein:
the inlet port is disposed at a lower end of the door,
a gap between an upper portion of the outer glass and an upper portion of the intermediate glass is larger than a gap between a lower portion of the outer glass and a lower portion of the intermediate glass,
a gap between the upper portion of the intermediate glass and an upper portion of the inner glass is larger than a gap between the upper portion of the outer glass and the upper portion of the intermediate glass, and
a gap between the lower portion of the intermediate glass and a lower portion of the inner glass is larger than a gap between the upper portion of the intermediate glass and the upper portion of the inner glass.
